(19) United States
(12) Patent Application Publication
(10) Pub. No.: US 2013/0293719 A1
(43) Pub. Date: Nov. 7, 2013

(54) TABLET COMPUTER STABILIZATION SYSTEM AND METHOD

(71) Applicant: Steven C. Ashe, Overland Park, KS (US)

(72) Inventor: Steven C. Ashe, Overland Park, KS (US)

(21) Appl. No.: 13/886,012

(22) Filed: May 2, 2013

Related U.S. Application Data
(60) Provisional application No. 61/641,525, filed on May 2, 2012.

(51) Int. Cl. H04N 7/18

(52) U.S. Cl. CPC H04N 7/185
USPC 348/157

(57) ABSTRACT

A sports training system employing a mounting apparatus and a tablet computer having an interactive user interface and a camera. The tablet computer is mounted to the mounting apparatus and used to record still pictures or live video of an athlete performing an athletic feat. The video may be reviewed by the athlete, a coach, or another professional. Comments may be drawn directly on the video or otherwise relayed to the athlete. The system may also compare successive attempts at the athletic feat to determine progress.

### CROSS-REFERENCE TO RELATED APPLICATIONS

This application claims priority in and incorporates by reference U.S. provisional patent application Ser. No. 61/641,525, filed May 2, 2013.

### BACKGROUND OF THE INVENTION

1. Field of the Invention

The present invention relates generally to a system and method for stabilizing a tablet computer for interactive photo and video recording, and more specifically to a system employing a mounting apparatus and interactive computing device for instant sports training feedback and suggestions for improvement in the areas of sports, athletics, and otherwise.

2. Description of the Related Art

Using technology to increase sport performance and sport training is nothing new. However, the best way to increase athletic performance is to have an educated coach or teacher watch the athlete and provide instant constructive feedback. This is all but impossible to do unless the athlete is practicing in front of an instructor.

Using video recording equipment to record an athlete's practice or actual performance technique can be helpful at reviewing specifics at a later time, but typical recording devices do not include a screen that would accommodate immediate feedback to the athlete at the time when the feedback is most useful.

Interactive tablet computers today typically include video capabilities and a large touchscreen interactive display. However, these devices are often somewhat cumbersome and are not ideal for recording detailed video useful for instruction, such as an athlete's golf swing. It is very difficult to keep the tablet steady enough to review the intricate details of a golf swing during review of the recorded video due to these difficulties.

What is needed is a system capable of ensuring that a tablet computing device including quality video recording and playback capabilities remains steady during recording such that instant feedback is available to the athlete for the purposes of instruction. Further, it would be ideal to ensure that the system is capable of providing feedback in all weather conditions, including full sunlight or during rainfall.

Heretofore there has not been available a tablet computer stabilization system and method with the advantages and features of the present invention.

### BRIEF SUMMARY OF THE INVENTION

The present invention generally provides a stabilizing mounting system with numerous features aimed at stabilizing a tablet computer for the purposes of recording and reviewing sporting activities for the purposes of instruction. The present invention includes numerous elements necessary to ensure that the tablet computer is securely attached to the mounting system during recording sessions, but is easily removed for review or other use.

The mounting system may be a tripod, a base, or a hand-held element. The primary purpose of the mounting system is to stabilize a tablet personal computer for use in the instruction in a field, such as sports training The tablet computer captures images or video and allows for playback of that video on an interactive touchscreen. This allows the user to interact with the video in numerous ways.

For example, a sports training system includes the ability to record and review video of sport activities. The user has the capability to slow down, speed up, re-watch, and even mark up the video to provide the best instruction to the athlete being recorded. The present invention may be used in front of an instructor, for personal use, or some combination of the two where the user records sport activities and then digitally sends them to a coach located at a remote location for near-instant commentary.

### BRIEF DESCRIPTION OF THE DRAWINGS

The drawings constitute a part of this specification and include exemplary embodiments of the present invention illustrating various objects and features thereof.

FIG. 1 is a perspective view of an athlete being observed in an embodiment of the present invention employing a tripod mounting apparatus.

FIG. 2 is a perspective diagram showing the interaction between elements of a preferred embodiment of the present invention.

FIG. 3 is a rear elevational view of a frame element for containing a tablet computing device as part of a preferred embodiment of the present invention.

FIG. 4 is a front elevational view thereof.

FIG. 5A is side sectional view of a tripod foot which is an element included in a preferred embodiment of the present invention.

FIG. 5B is a top plan view thereof.

FIG. 5C is a front elevational view thereof.

FIG. 5D is a side elevational view thereof.

FIG. 6 is a perspective view of an embodiment of the present invention employing a hand-held mounting apparatus.

FIG. 7 is a front elevational view of the handle element employed within an embodiment of the present invention.

FIG. 8 is a perspective view of an embodiment of the present invention employing a base for mounting the handle element of FIGS. 6 and 7.

FIG. 9 is a top plan view of the base element of FIG. 8.

FIG. 10 is a perspective view demonstrating the relationship between multiple elements employed in an embodiment of the present invention.

FIG. 11 is a front elevational view of a frame element employed within an embodiment of the present invention including numerous optional attachments.

FIG. 12 is a perspective view of an alternative embodiment of the present invention.

FIG. 13 is a detailed perspective view of the frame element and mounting arm thereof.

FIG. 14A is a side elevational view of the mounting arm thereof.

FIG. 14B is a top plan view thereof.

FIG. 14C is a front elevational view of an alternative mounting arm.

FIG. 15 is a side perspective view of the alternative embodiment of the present invention.

FIG. 16 is a perspective view of yet another alternative embodiment employing a mounting base.

FIG. 17A is a top plan view of the base thereof.

FIG. 17B is a front elevational view thereof.

FIG. 17C is yet another front elevational view thereof.

### DETAILED DESCRIPTION OF THE PREFERRED EMBODIMENTS

### I. Introduction And Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Sports Training System 2

This invention is aimed at utilizing a versatile tablet computer 8, such as Apple, Inc.'s iPad®, for sports video recording and instructing purposes. The present invention considerably enhances a tablet computer's capabilities as a video training system by combining the tablet with a tripod 10 or other stabilizing mounting apparatus 4. This tripod may be substantially re-engineered so as to benefit the user in the process of video-taping various sports activities. The tablet “jacket” or “frame” 12 is designed to encompass the sides and back of the tablet acting as a frame to hold it securely in place so it can be attached to the tripod. Additional benefits of the frame 12 are the inclusion of three accessory clips 14 along the edges of the frame for adding accessories such as microphones and lights.

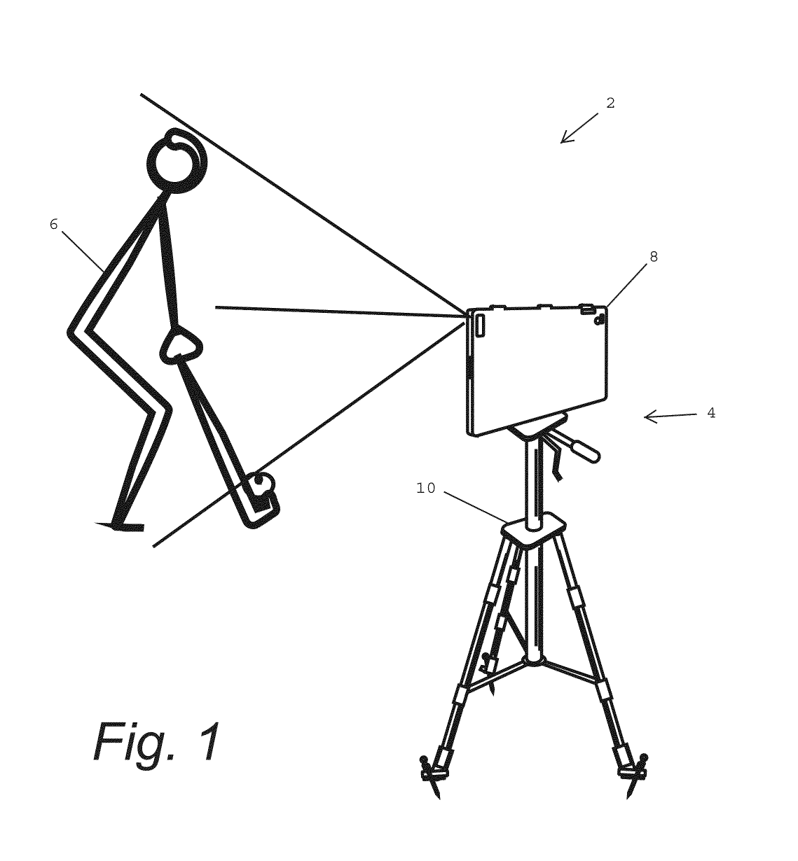

FIG. 1 demonstrates the preferred embodiment sports training system 2 viewing an athlete 6 (here a golfer) using a tablet computer 8 on a mounting apparatus 4, herein embodied by a tripod base 10. The tablet computer must necessarily include several elements, including a central processing unit (CPU), data storage element, a display, and a camera 72. The display is preferably a touchscreen interface 52, and the camera 72 is preferably able to capture moving pictures.

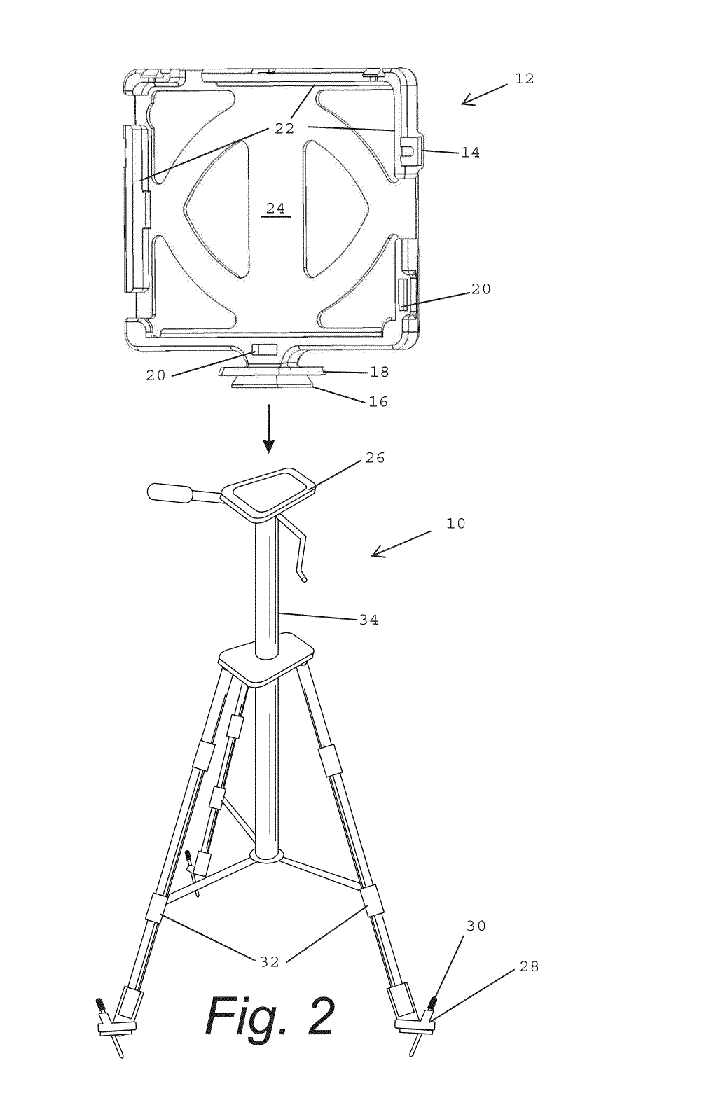

FIG. 2 demonstrates the frame 12 capable of housing the table computer 8 and mounting to a tripod 10. The frame 12 includes a number of clips 14 for mounting photography accessories such as microphones and lights. The frame employs a lip 22 and a backing element 24 for containing and protecting the tablet computer. The frame may include a number of levels 20 for ensuring that the tablet is squarely mounted to the tripod 10. The frame also includes a frame connector 16 and a frame connector platform 18.

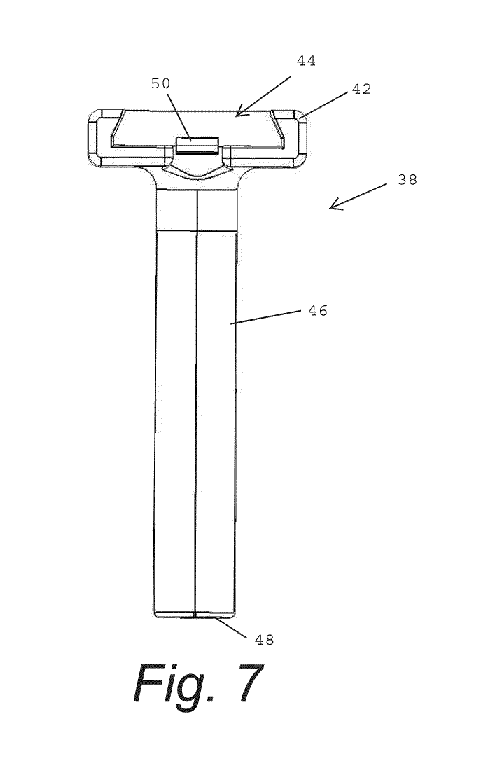

The tripod 10 includes a tripod receptacle 26 similar to the connection interface receiver slot 44 including a releasable receiver clip 50 shown in FIG. 7. This allows the frame connector 16, which generally employs a wedge-shaped cross section, to slide into the receptacle 26 and snap into place using a receiver clip 50. The receiver clip 50 may be depressed to release the frame connector 16 and, therefore, the frame 12. The frame connector platform 18 acts as a guide for mounting the frame 12 to the tripod 10.

The tripod 10 employs most typical tripod elements, including a telescoping central post 34 and telescoping extendable legs 32. Each leg terminates into a foot 28. A preferred embodiment includes a foot 28 with a securing spike receiver 70 for inserting a securing spike 30. This allows the tripod to be firmly mounted to the earth, and will prevent wind or other unexpected forces from tipping the tripod and damaging the tablet computer 8. Alternatively, the spike could be driven straight through the leg of an existing tripod 10 which has been modified to receive the frame 12, or to which the frame 12 has been modified to fit.

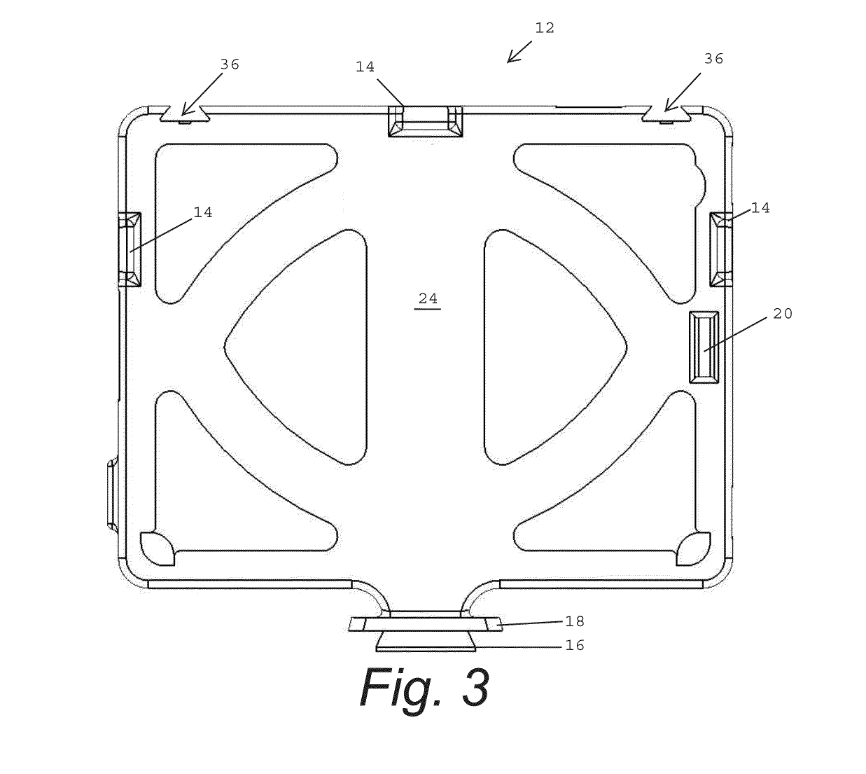

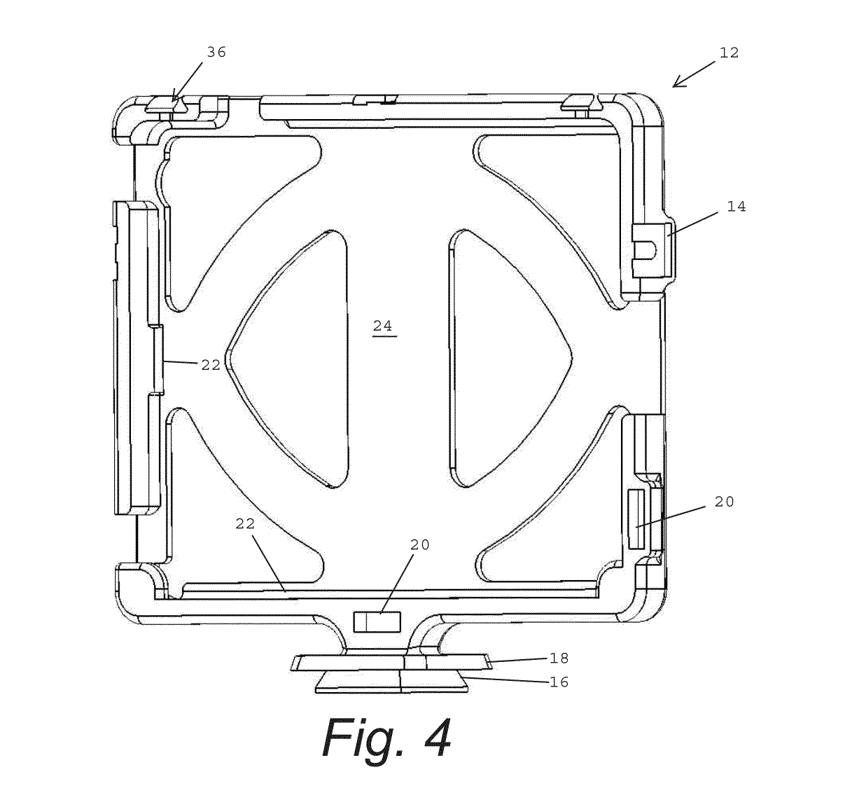

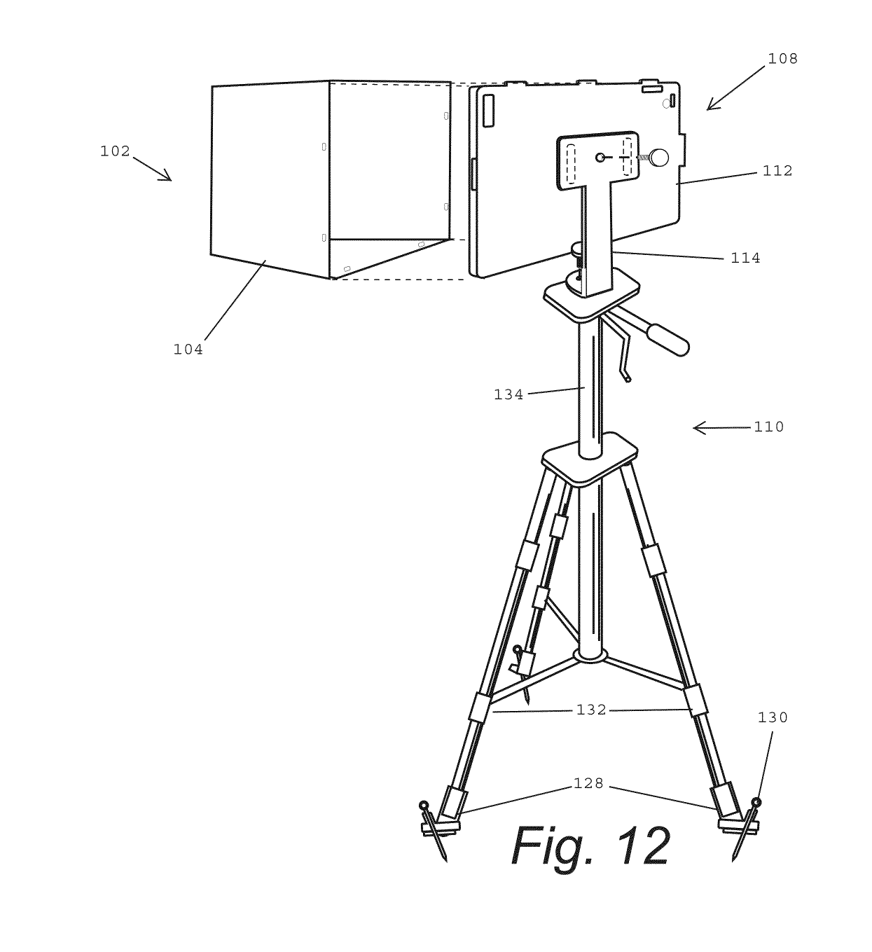

FIGS. 3 and 4 show a more detailed view of the frame 12. In addition to the elements mentioned above, the frame may include frame lock inserts 36 which accept hand screw frame locks 66 (as shown in FIG. 12). These locks employ thumb screws and are used to secure the tablet computer 8 to the frame 12.

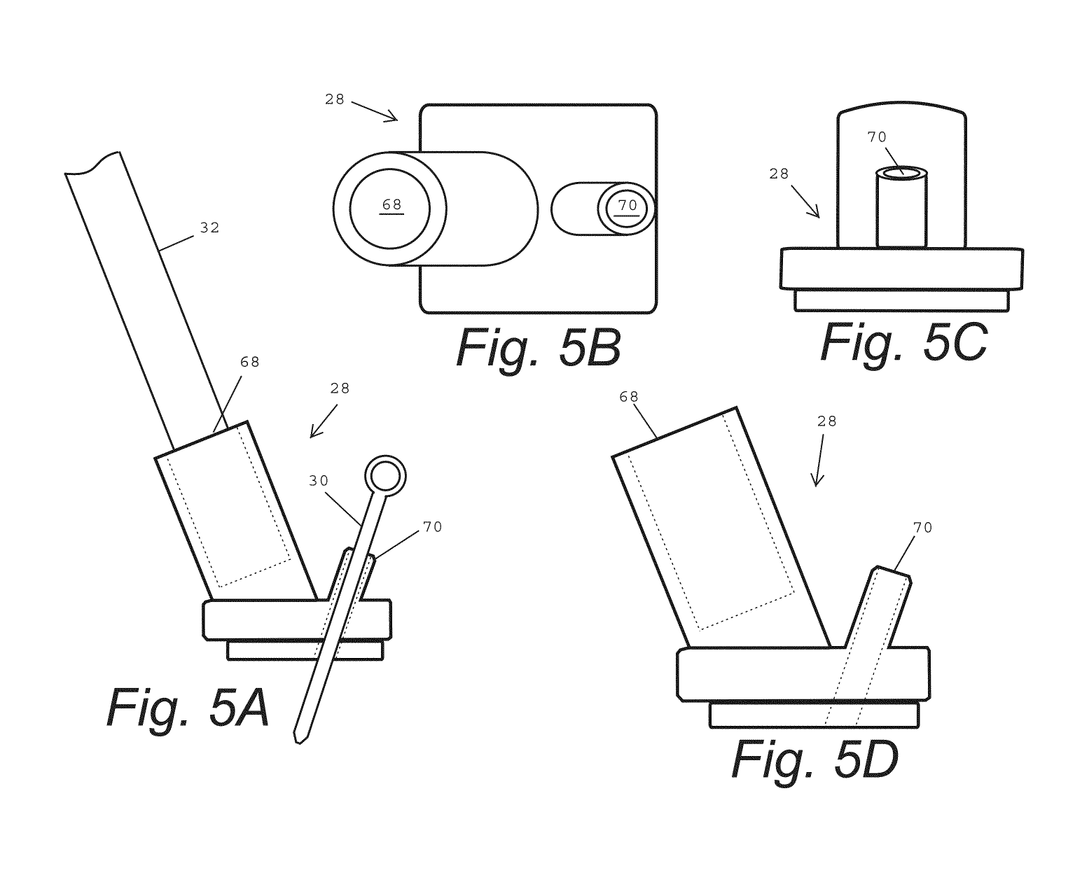

FIGS. 5A-D demonstrate the use of the tripod feet 28 and the securing spikes 30. The feet 28 include a tripod leg interface 68 for accepting the insertion of a tripod leg, and a securing spike receiver 70 for accepting the insertion of a securing spike 30.

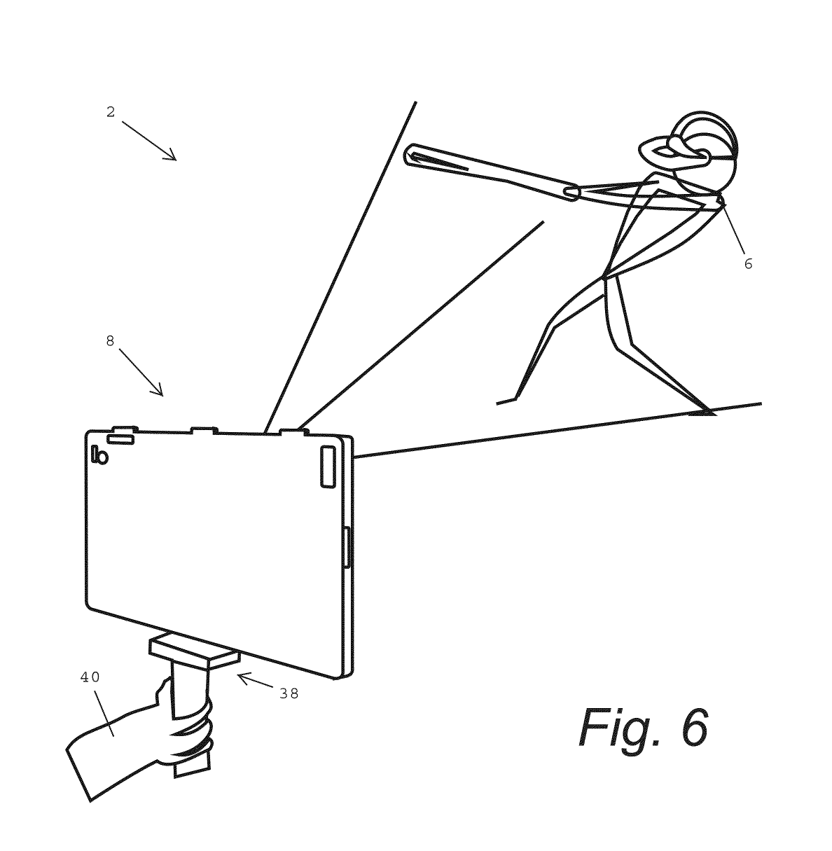

FIG. 6 demonstrates the use of a hand-held mounting apparatus 38 and employing it in the sports training system 2. This mounting apparatus may be detachable from the telescoping central post 34 of the tripod 10 discussed above, or it may be a completely separate element. The mounting apparatus 38 is ergonomically designed to be held by a human hand 40.

As shown in FIG. 7 and discussed above, the hand-held mounting apparatus 38 includes a receptacle 42 with a receiver slot 44 for accepting the frame connector 16 of the frame 12. A releasable clip 50 holds the frame connector 16 in place within the receiver slot 44. A post 46 is affixed to the base of the receptacle 42, and ideally is ergonomically shaped. The post 46 includes a post-base 48.

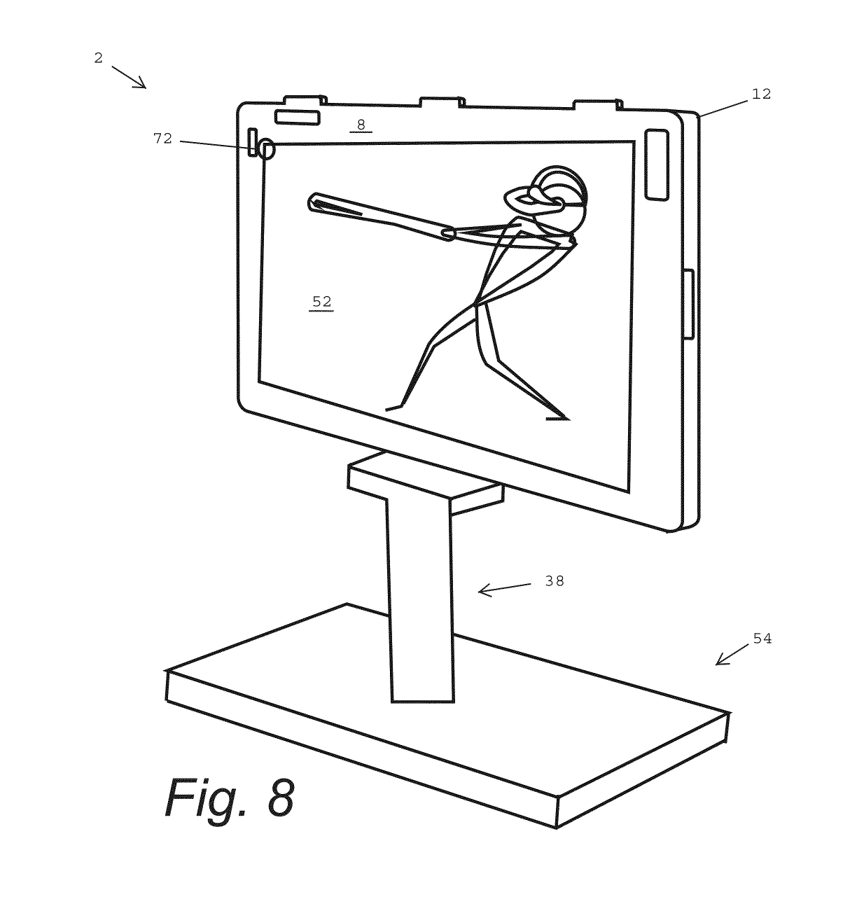

FIG. 8 shows the hand-held mounting apparatus 38 affixed to the frame 12 and mounted to a mounting base 54. The mounting base secures the post 46, but the post may be unmounted by simply lifting the post-base 48 away from the mounting base 54. FIG. 8 also shows the camera's 72 position next to the touchscreen interface 52.

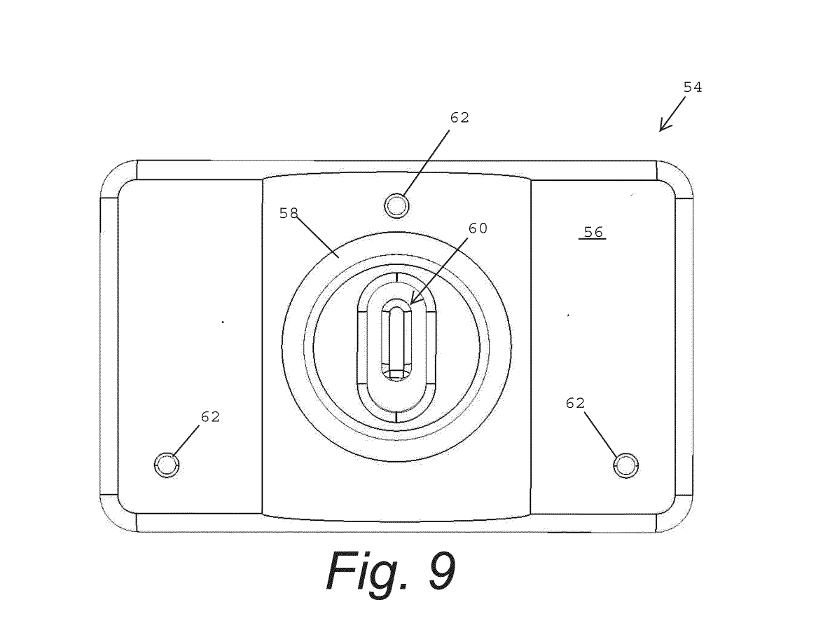

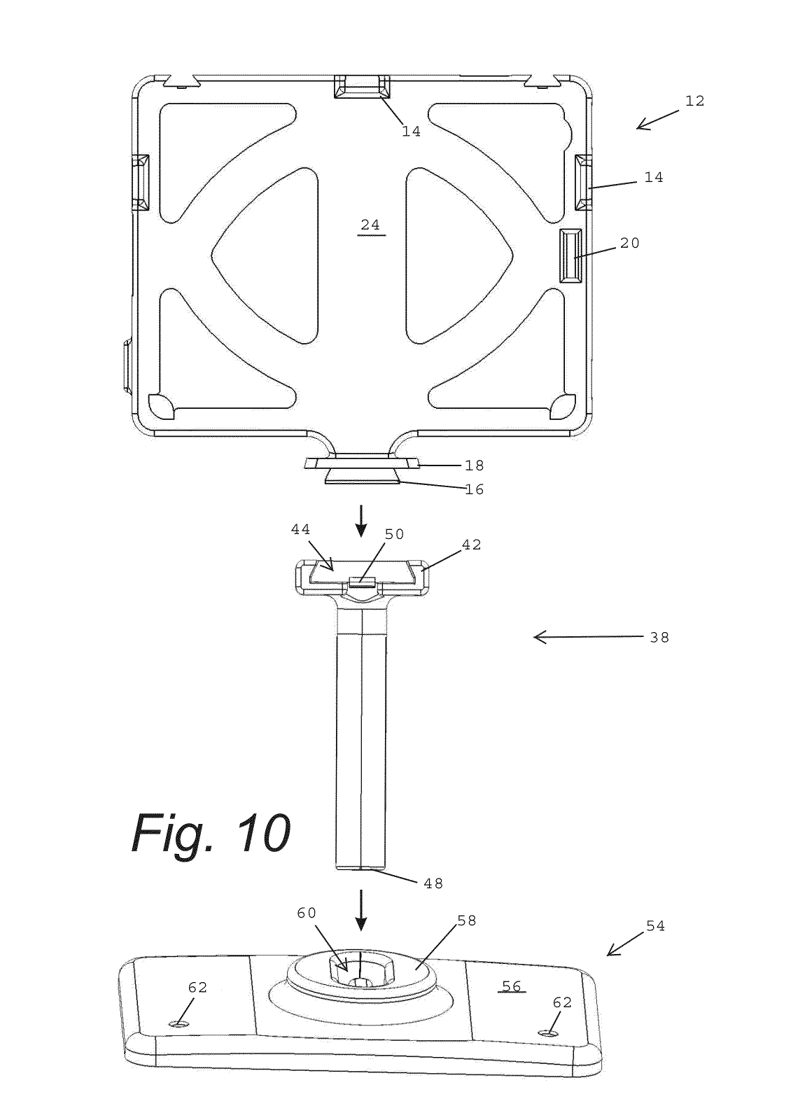

FIG. 9 shows the mounting base 54 in more detail, including securing spike receivers 62, a base plate 56, and a receptacle 58 including a receiver slot 60 for accepting the post-base 48 of the hand-held mounting apparatus 38. It is shown that the size and shape of the post-base 48 is generally conformed to the size and shape of the mounting base receiver slot 60. This is shown more clearly in FIG. 10.

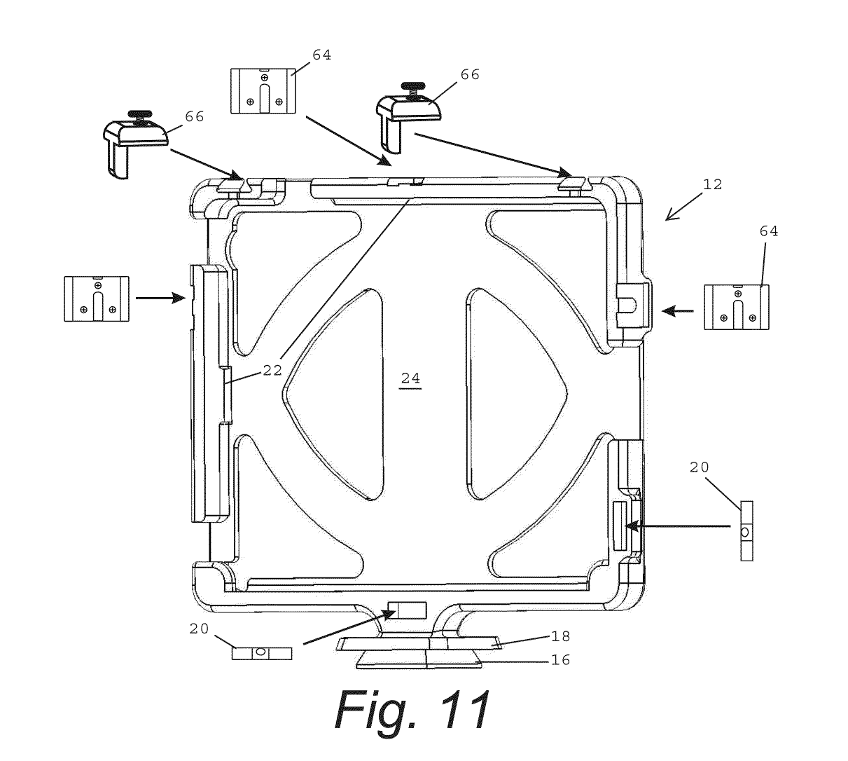

FIG. 11 shows the frame 12 discussed previously, including a number of accessories to improve usability. These accessories include photography mounting shoes 64 which attach to the clips 14 of the frame 12. Further, these accessories include the hand screw frame locks 66 discussed previously.

FIGS. 1-11 together present the physical elements capable of allowing the sports training system 2 to work. The tablet computer 8 is mounted in a frame 12 which protects the computer and allows the computer to be mounted to a mounting apparatus such as a tripod 10 or a hand-held mounting post 38. The mounting means may even change on a minute-to-minute and activity-to-activity basis, as deemed appropriate by the athlete 6 or the athlete's coach.

Once the tablet computer is in position, either mounted on a tripod, hand-held, or otherwise, the tablet computer may begin recording video of the athlete in action. This may include swinging a golf club, swinging a baseball bat, throwing a football, swimming a lap, or any other athletic feat.

Upon completion of the feat, the video is immediately available for review by the athlete 6, the coach, or any other interested parties. The tablet computer may include software capable of editing the video, such as allowing the user to draw directly over the video, or to speed up, slow down, or otherwise alter video playback. Ideal software would allow the user or coach to highlight inefficient movements in the athlete's performance, or other areas of focus in the athletic feat being critiqued.

Additionally, the tablet computer may be connected to a wireless network capable of communicating with other computers. In such a case, the user may upload the video to a website or send the video to another person (such as a coach) at a remote location. The video may be reviewed, edited, and marked-up by others, and then sent back to the original user or athlete. This can be done in near real time, and could facilitate the coaching and improvement of a vast number of athletes by not requiring personal one-on-one coaching for optimum results.

The athlete may then perform the feat again. The tablet computer will record the feat a second time. The software may be capable of comparing the most recently recorded feat with previous attempts. This data can be used to indicate whether the athlete is listening and responding to instruction and thereby correcting his or her form.

### III. Alternative Embodiment System 102

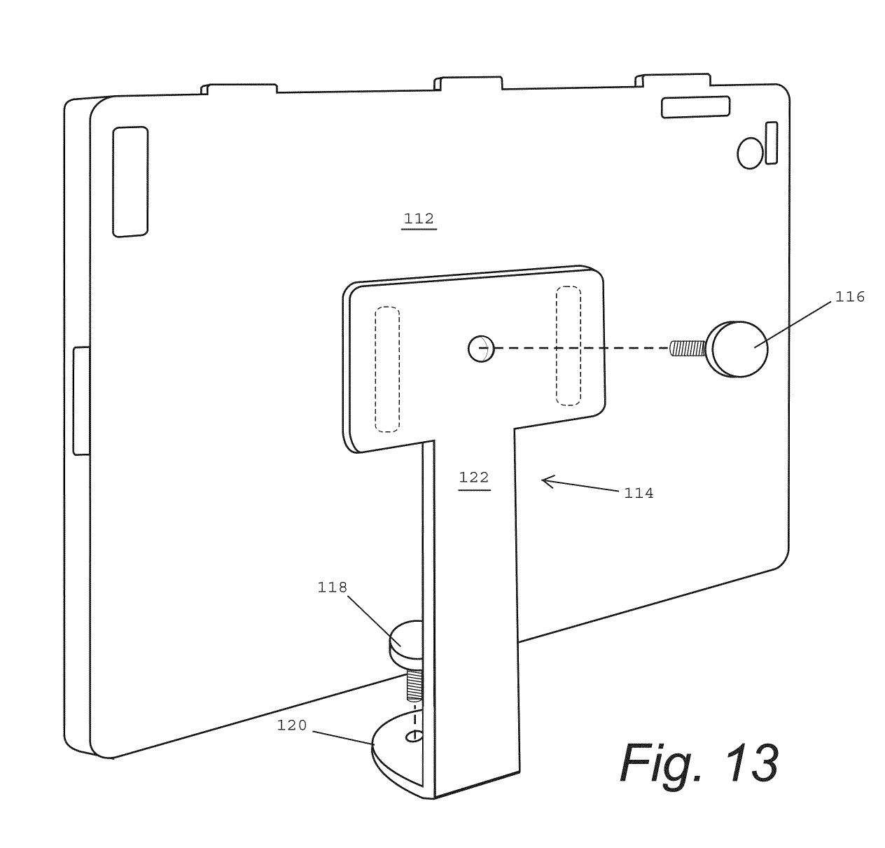

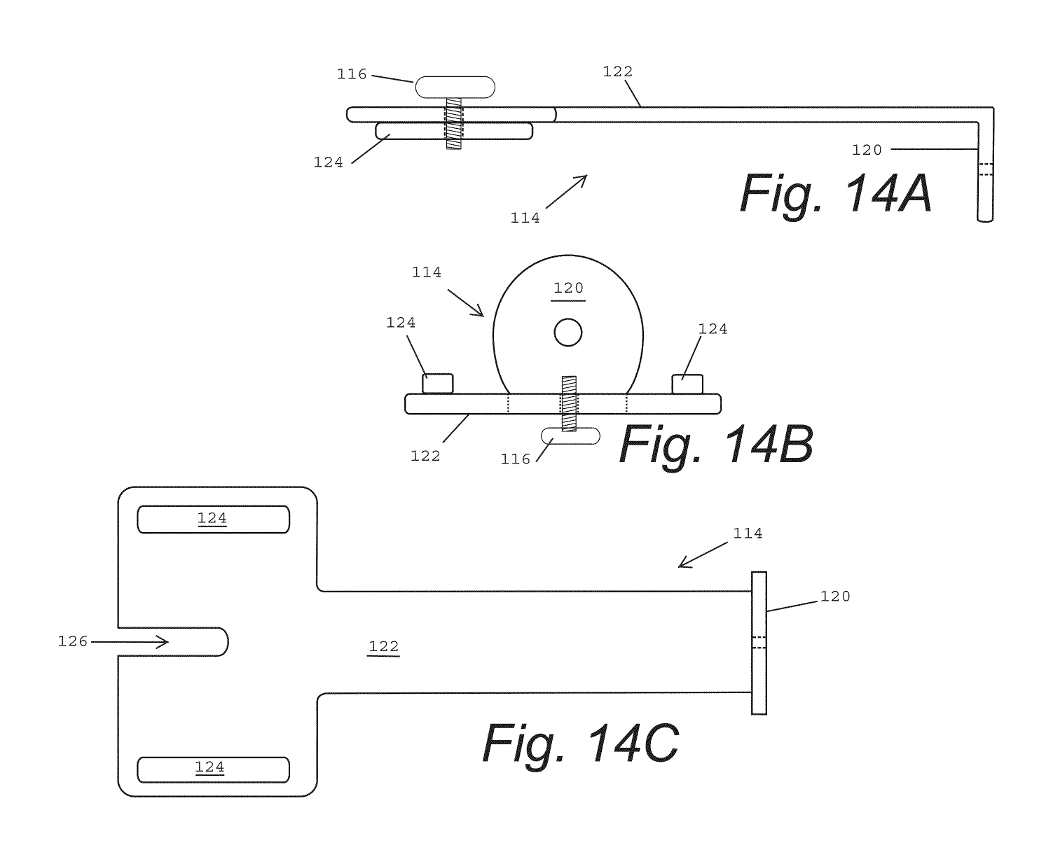

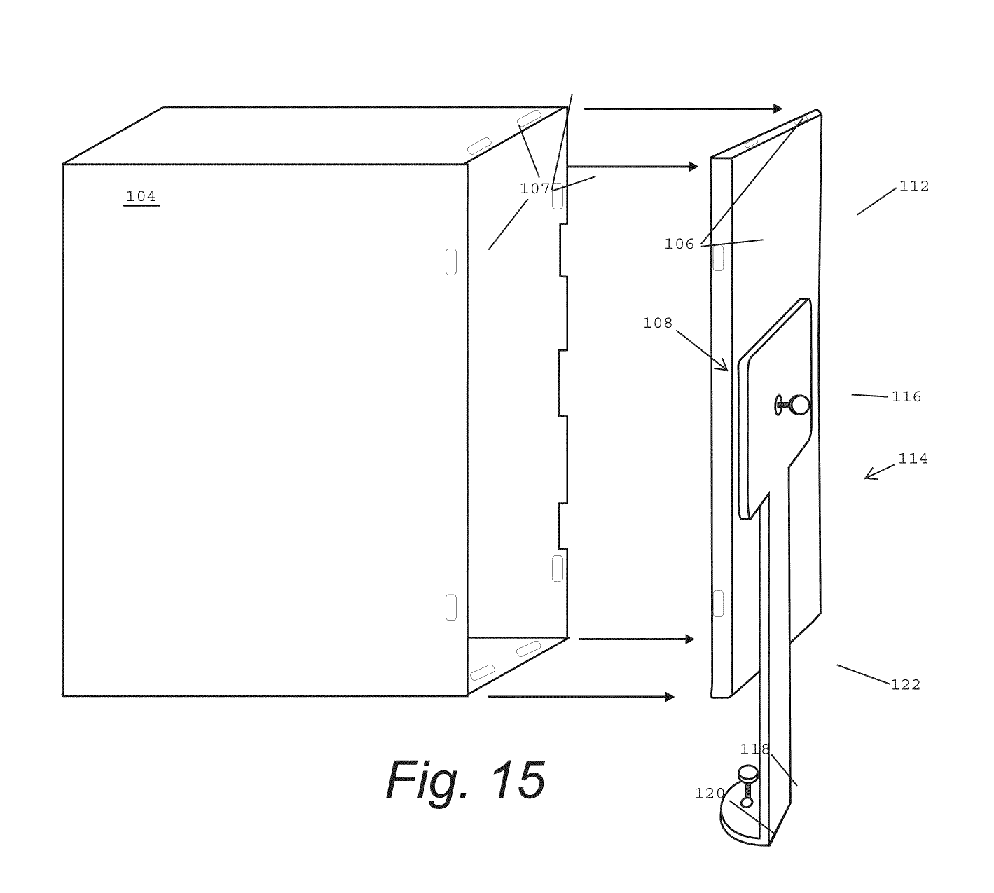

FIGS. 12-15 demonstrate an alternative embodiment sports training system 102. This system includes a slightly alternate mounting means for mounting a tablet computer 108 to a tripod 110 including a telescoping center post 134, extendible legs 132, and feet 128 secured with securing spikes 130. A mounting arm 114 is employed in this embodiment. The arm mounts to the frame 112 via a frame mounting screw 116, and mounts to the tripod 110 via a tripod mounting screw 118.

The mounting arm includes a “shoe” 120 and a “backing” 122. A pair of spacers 124 are mounted to the backing 122 which protects the frame 112. The frame screw 116 penetrates a hole in the backing 122 and is threaded directly into the frame 112. Alternatively, the backing may include a notch 126. A light hood 104 accessory can be attached to the frame by use of integrated magnets 106, 107. The light hood 104 may be used to shield the screen from the sun. This allows the user to review video on the screen even in glaring outdoor sunlight.

### IV. Alternative Mounting Means

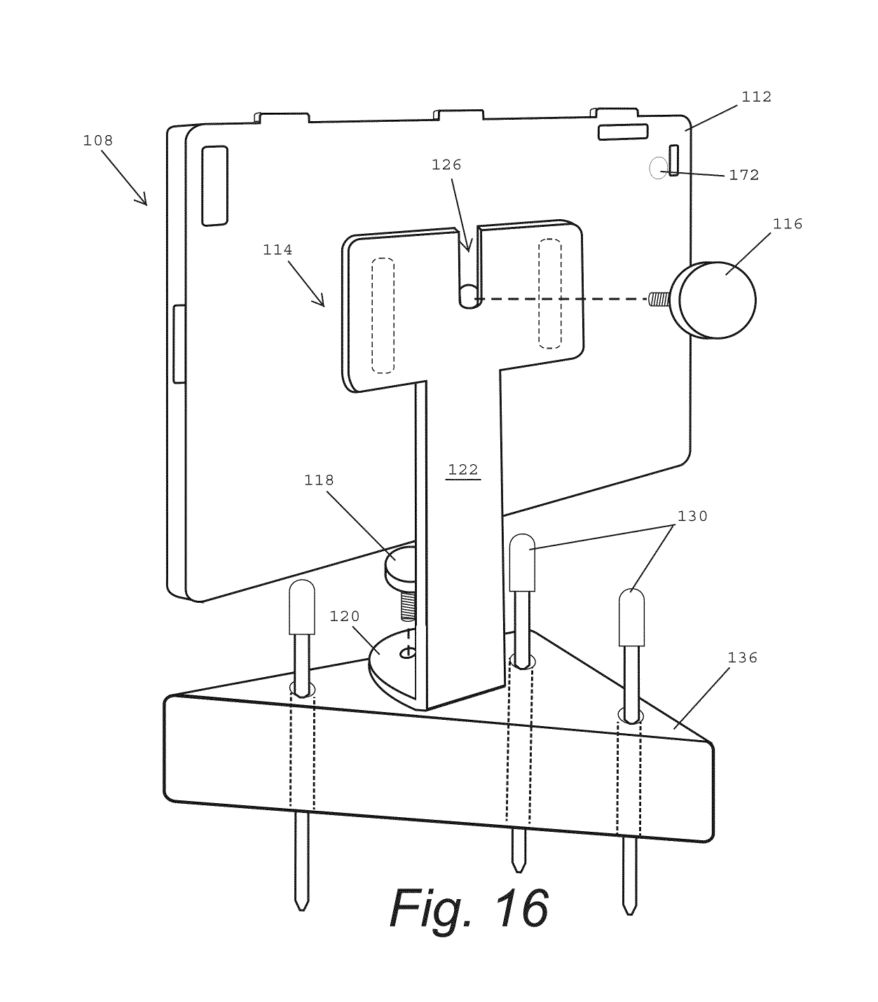

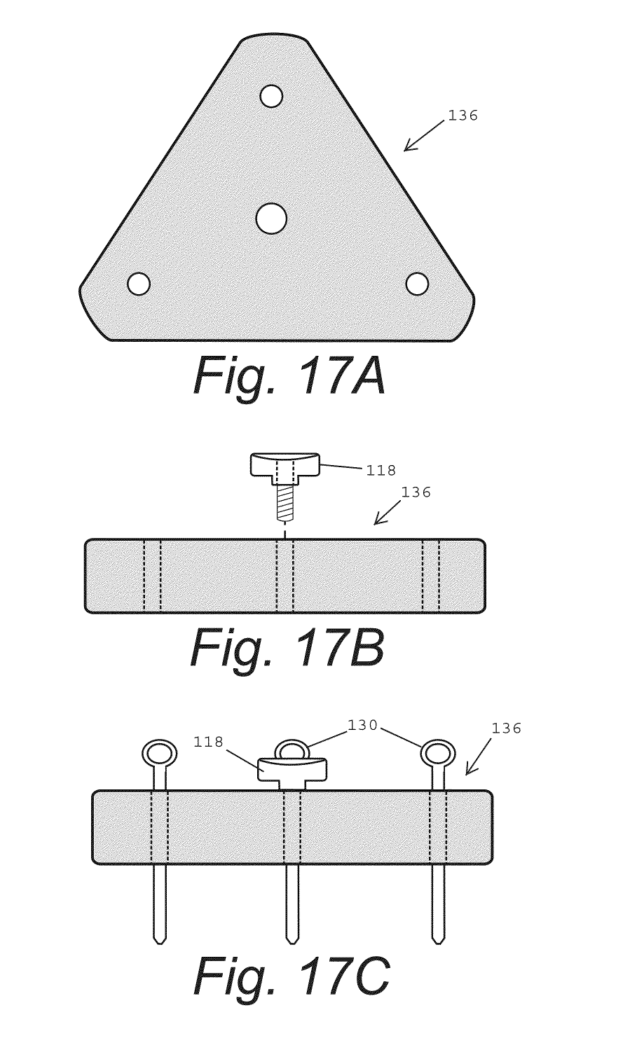

FIGS. 16-17C demonstrate an alternative mounting means for the sports training system 102. The shoe 120 of the mounting arm 114 is instead mounted to a base block 136. The base block is secured to a table, the ground, or another object via securing spikes 130. FIG. 16 shows a camera 172 located on the reverse face of the tablet computer 108, and an opening in the frame 112 which allows the camera to function when the frame is attached.

The primary example used above references using the present invention for sports training. This is just one example of the use of this invention. The invention could be used in other fields of education or instruction, or in everyday life for recording and reviewing images.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A stabilization system for an interactive computing device including an image recording device, the system comprising:
a computing device including a CPU, a memory storage device, a display, and a camera;
a frame, said computing device being mounted within said frame;
a mounting apparatus, said frame being mounted to said mounting apparatus;
wherein said computing device camera is adapted to record images; and
wherein said computing device display is adapted to display said images.

2. The system of claim 1, further comprising:
wherein said computing device comprises a tablet personal computer and wherein said display comprises a touchscreen interface; and
said display adapted to allow notes to be overlaid over said recorded images via said touchscreen interface.

3. The system of claim 2, further comprising:
said frame including a lip adapted for encompassing the edges of said tablet personal computer;
said frame further including at least two clips for securing said tablet personal computer to said frame; and
said frame further including a mounting interface adapted for interfacing with said mounting apparatus.

4. The system of claim 3, further comprising:
said mounting interface including a primary connector and a platform;
said primary connector having generally a wedge shape, wherein said primary connector's bottom face has a larger area than its top face; and
wherein said platform is located above said primary connector.

5. The system of claim 4, further comprising:
said mounting apparatus including a post having a proximal end and a distal end;
said post proximal end including a mounting interface receiver generally conforming to the shape of said primary connector; and
said mounting interface receiver further comprising a depressible release clip adapted for releasably securing said primary receiver within said mounting interface receiver.

6. The system of claim 5, further comprising:
wherein said mounting apparatus is a tripod wherein said post comprises a central telescoping post of said tripod, and wherein said tripod further comprises three extendable legs;
each of said three extendable legs terminating at a distal end; and
three securing spikes adapted to secure the distal end of each said tripod extendable legs to a surface.

7. The system of claim 6, further comprising:
a foot including a leg cavity and a spike cavity being mounted to said distal end of each said extendable leg via a leg cavity; and
said securing spikes to be inserted into said foot spike cavity, thereby securing said foot to said surface.

8. The system of claim 5, further comprising:
said post distal end comprising an interface tip;
a mounting base comprising a base plate, a plurality of securing spike receivers, and an interface receiver having a depression corresponding to said post distal end interface tip; and
wherein said mounting base receiver is adapted to receive said post interface tip such that said post is aligned vertically with respect to the earth.

9. A stabilization system for an interactive computing device including an image recording device, the system comprising:
a computing device including a housing, CPU, a memory storage device, an interactive touchscreen display interface, and a video camera;
a mounting apparatus, said frame being mounted to said mounting apparatus;
a frame including a lip adapted for encompassing the edges of said computing device housing, said frame further including at least two clips for securing said computing device housing to said frame;
said frame further including a mounting interface adapted for interfacing with said mounting apparatus, said computing device being mounted within said frame;
said mounting interface including a primary connector and a platform;
said primary connector having generally a wedge shape, wherein said primary connector's bottom face has a larger area than its top face, and wherein said platform is located above said primary connector;
said mounting apparatus including a post having a proximal end and a distal end;
said post proximal end including a mounting interface receiver generally conforming to the shape of said primary connector;
said mounting interface receiver further comprising a depressible release clip adapted for releasably securing said primary receiver within said mounting interface receiver;
wherein said computing device video camera is adapted to record images of an athlete performing an athletic feat;
wherein said touchscreen display interface is adapted to display said images of said athletic feat; and
wherein notes may be applied to said images using said touchscreen display interface.

10. A method of stabilizing a computing device having an image recording device for the purposes of evaluating images recorded by said image recording device, the method comprising the steps:
providing a computing device including a housing, CPU, a memory storage device, a display, and a camera;
providing a mounting apparatus including a frame and a stand;
placing said computing device within said frame such that said camera is aimed at an athlete;
mounting said frame to said stand;
recording images of said athlete performing an athletic motion; and
displaying said images of said athlete performing said athletic motion on said computing device display.

11. The method according to claim 10, wherein said computing device comprises a tablet personal computer and wherein said display comprises an interactive touchscreen interface adapted to allow notes to be written over said recorded images.

12. The method according to claim 11, further comprising the steps:
placing said computing device within a lip located around the edge of said frame;
securing said computing device to said frame using a pair of mounting brackets, each of said mounting brackets including a mounting screw; and
mounting said frame to said post via a mounting interface located on said frame and a mounting receptacle located on a proximal end of said post.

13. The method according to claim 12, wherein said mounting interface includes a conically-shaped connector and a platform located above said connector.

14. The method according to claim 13, wherein said mounting receptacle includes a receiver slot corresponding to the shape of said connector, and a depressible receiver clip capable of releasably securing said connector within said receiver slot.

15. The method according to claim 14, comprising the steps:
sliding said connector into said receiver slot, such that said platform is located above the top edge of said mounting receptacle;
locking said connector into said receiver slot with said depressible receiver clip;
depressing said receiver clip; and
removing said connector from said receiver slot, thereby unmounting said frame from said post.

16. The method according to claim 14, wherein said post includes a distal end comprising an interface tip, the method further comprising the steps:
providing a mounting base comprising a base plate, a plurality of securing spike receivers, and an interface receiver having a depression corresponding to the interface tip of said post distal end;
placing said interface tip into said mounting base interface receiver such that said post is aligned vertically with respect to the earth; and
securing said mounting base to a surface using a plurality of securing spikes driven through said securing spike receivers.

17. The method according to claim 14, wherein said post comprises a telescoping central post of a tripod, said tripod including three telescoping legs terminating at distal leg ends, the method further comprising the steps:
extending said telescoping legs away from said central post;
placing the distal leg ends against a surface; and
securing said distal leg ends to said surface using a plurality of securing spikes.

18. The method according to claim 17, further comprising the steps:
providing a foot for each of said telescoping legs, each said foot including a tripod leg interface and a securing spike receiver;
placing a foot onto the distal leg end of each of said telescoping tripod legs; and
placing the securing spikes through said securing spike receiver of each of said feet.
